(19) United States
(12) Patent Application Publication
(10) Pub. No.: US 2021/0402314 A1
(43) Pub. Date: Dec. 30, 2021

(54) MODULAR SYSTEM FOR CONSTRUCTING TEMPORARY ENCLOSURES

(71) Applicants: Darren B. SKULSKY, Coral Springs, FL (US); Vladyslav V. RYZHYKOV, Kyiv (UA)

(72) Inventors: Darren B. SKULSKY, Coral Springs, FL (US); Vladyslav V. RYZHYKOV, Kyiv (UA)

(21) Appl. No.: 16/913,167

(22) Filed: Jun. 26, 2020

(51) Int. Cl. A63J 1/02; E04H 3/22; F16C 19/54

(52) U.S. Cl. CPC A63J 1/02; F16C 19/54; E04H 3/22

(57) ABSTRACT

There is provided a modular system for assembling a structure including a frame formed of a plurality of metal profiles. The system includes one or more joints, each including at least one slot and configured for attaching one of the metal profiles to another one of the metal profiles and one or more pairs of wall piece elements. Each pair of wall piece elements attaches one section of a wall to one section of one of the metal profiles; each element including at least one slot. Also included is a plurality of fasteners, one of the plurality of fasteners (i) corresponding to one of the slots (ii) and configured for securing attachment of at least one of the respective joints or one element of the pair to the metal profile. Another one of the plurality of the fasteners is configured for securing attachment of the other element of the pair to the wall.

### I. TECHNICAL FIELD

The present invention relates to constructing enclosures and other structures. In particular, the present invention relates to interchangeable constructor components for expediting construction of movie or production sets and other temporary enclosures.

### II. BACKGROUND

In the theater or film industry, a studio is a location where movie (i.e., production) sets are constructed to compensate for real or imagined places that do not exist or otherwise cannot be shot during actual filming. That is, production sets are props used as cheaper and faster alternatives to traveling to an actual location for scenery when shooting a film.

When building a production set, such as a living room or a kitchen, as an example, a widely used and conventional industry approach exists. This approach includes an initial phase of constructing frames using two-by-four (2×4s) with plaids holding the 2×4s in place. After completion of this initial phase, the remainder of the production set is built out like a normal house.

The production set can be made of plywood, drywall, particle board, or any other flat, with molding and all the other materials used in normal house construction. FIG. 1 is an illustration of a conventional production set 100 including walls 102. The walls 102 are constructed of 2×4s 104 held into place by frame 106. Although production sets, such as the production set 100, provide sufficient realism, the time and materials associated with their construction is enormous. For example, there is a considerable amount of money spent for lumber and other materials that will only be used one time.

Each production set amounts to a brand-new construction project with limited reusable or transportable pieces, from one set to another set. As a result, construction of conventional production sets requires a considerable allocation of time, money, and manpower for completion. Making last-minute changes in these conventional production sets, something as simple as changing the shape of a window or moving the location of a door, can require enormous additional resources.

After the filming has been completed, the entire production set is torn down and the pieces are discarded. In this manner, the conventional production sets can have a significantly harmful impact on the environment given the temporary and one time use of the construction materials.

Existing alternatives to the conventional approach include techniques focused on complex modular wall components. These complex modular wall components are used in a manner similar to Lego™ components. The modular wall components, for example, permit electrical and plumbing inside of the walls and permit sets to be constructed with lights and openings for doors. Given the focus on walls alone, this approach has not been widely used in the film industry. Additional approaches focus, for example, on assembling furniture items. These other additional approaches, however, are also unable to accommodate design changes “on the fly,” facilitate rapid deconstruction and reuse or incorporate moving components, and are therefore of limited utility.

### III. SUMMARY

The embodiments featured herein help solve or mitigate the above noted deficiencies as well as other issues known in the art. For instance, exemplary systems and methods as described below, facilitate construction of production sets that can be assembled faster, cheaper, with less labor, and with much less waste than conventional production sets.

Specifically, the embodiments described herein include multiple modular reusable joints that connect together standard metal (e.g., aluminum) profiles to construct production sets. The aluminum profiles, which embodiments of the invention may be affixed to, form the basic frame of the production set. They are typically rigidly shaped such that things can be hung to them, fit inside, and slide onto them.

The metal profiles, usually made of aluminum, are generic components and are available in hardware stores in any home market. After use of a production set has concluded, the set can be deconstructed. The components of the deconstructed set can be used later to construct an entirely different production set.

Under certain circumstances, an embodiment of the present invention provides a modular system for assembling a structure including a frame formed of a plurality of metal profiles. The system includes one or more joints, each including at least one slot and configured for attaching one of the metal profiles to another one of the metal profiles and one or more pairs of wall piece elements. Each pair of wall piece elements attaches one section of a flat to one section of one of the metal profiles; each element including at least one slot. Also included is a plurality of fasteners, one of the plurality of fasteners (i) corresponding to one of the slots (ii) and configured for securing attachment of at least one of the respective joints or one element of the pair to the metal profile. Another one of the plurality of the fasteners is configured for securing attachment of the other element of the pair to the flat.

Embodiments of the invention have applicability beyond the film industry. For example, the embodiments can be used to provide quick pop up housing during disaster planning/relief, for outdoor flea market configurations, and in a number of other markets. Additionally, production sets constructed in accordance with the embodiments are also recyclable.

Additional features, modes of operations, advantages, and other aspects of various embodiments are described below with reference to the accompanying drawings. It is noted that the present invention is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### IV. BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a conventional production set.

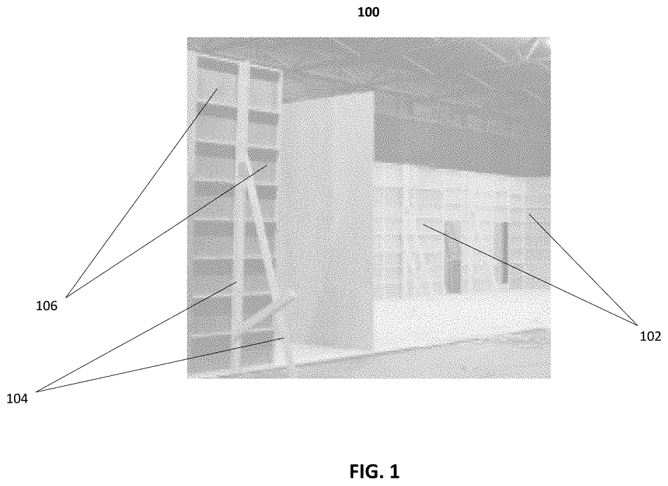

FIG. 2 illustrates use of an exemplary embodiment of the present invention for constructing a portion of a production set.

FIG. 3 illustrates an aluminum profile upon which the embodiments may be implemented.

FIG. 4 illustrates exemplary components associated with the components shown in FIG. 2.

FIGS. 5A-5C illustrate various joint type components associated with the embodiments.

FIG. 6 illustrates exemplary sheet fixing components constructed in accordance with the embodiments.

FIGS. 7A and 7B illustrate an exemplary fastener constructed in accordance with the embodiments.

FIGS. 8A and 8B illustrate an exemplary quick release wheel and a regular wheel constructed in accordance with the embodiments.

FIG. 9 illustrates an exemplary key constructed in accordance with the embodiments.

FIG. 10 illustrates attachment of a flat to an aluminum profile using the sheet fixing components of FIG. 6.

FIG. 11 is a flowchart of an exemplary method of practicing an embodiment of the present invention.

### V. DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

The embodiments of the present invention include a modular construction system formed of a plurality of connection components connectable to a metal profile to collectively form the frame or skeleton of a production set. The exemplary components include various types of fasteners and joints configured for attaching one metal profile to another metal profile to form the frame. These profiles, typically aluminum, are standard construction elements (i.e. workpieces) that are readily available internationally.

As noted above, the embodiments facilitate rapid construction and deconstruction of production sets. This approach reduces the time required to build sets, reduces the amount of trained carpenter labor, and reduces waste associated with film production set construction. The exemplary modular construction system of the embodiments is also configured for quick deconstruction and reuse.

By way of example only, and not limitation, the various types of fasteners and joints include fixing elements, wheels, fasteners, and the key. These components, discussed in greater detail below, are constructed of roughly the same material thickness—important for multi functionality and compatibility and include common equally spaced slots for connection of profiles and fasteners. Further, the components are designed to speed up the process of constructing and deconstructing production sets such that all the components and materials may be reused, increasing efficiency, lowering costs, and reducing waste.

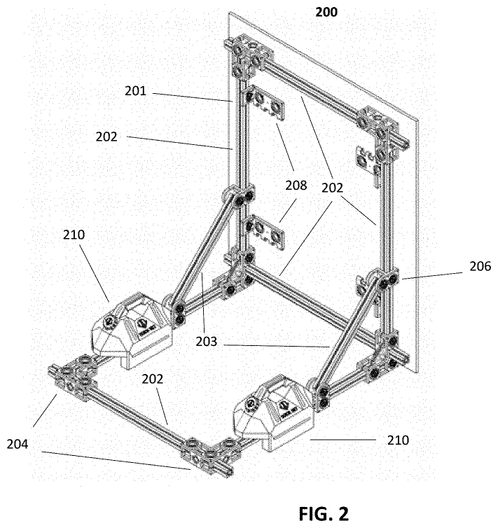

In another embodiment, components in the system are color coded and use glow-in-the-dark plastic which facilitates working in low-light conditions helping workers better navigate the construction process. A more detailed explanation of the embodiments is provided in the description of FIGS. 2-11 provided below.

FIG. 2 illustrates an exemplary modular construction system for building a frame section 200 of a production set in accordance with the embodiments. The illustration of FIG. 2 depicts operation of the modular construction system at a high level. In FIG. 2, the frame section 200 includes a wall portion (flat) 201 affixed to long aluminum profiles 202. The long aluminum profiles 202 form the skeleton or frame not only for the frame section 200, but for the remainder of the production set (not shown). In the exemplary embodiment depicted in FIG. 2, the aluminum profiles are joined together using a portion of the plurality of components noted above.

In FIG. 2, the long aluminum profiles 202 are joined together using corner joints 204, discussed more fully below. Shorter aluminum profiles 203 connect to the longer profiles 202 and act to stabilize the long profiles 202 specifically, and the frame portion 200 generally. Guiding joints 206 connect the short aluminum profiles 203 to the longer profiles 202. Fixing elements 208 connect the aluminum profiles 202 to the flat 201. Exemplary weights 210, connect to the long profiles 202 and serve as a counterbalance to hold the frame section 200 in position.

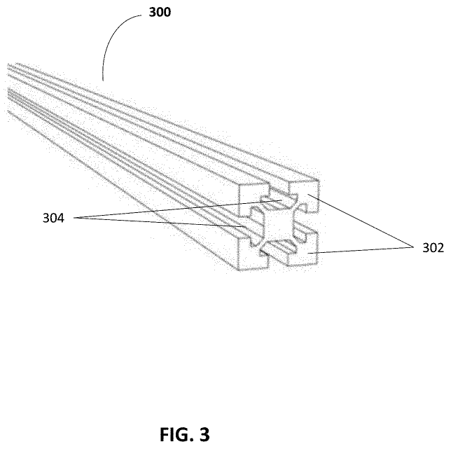

FIG. 3 illustrates a standard aluminum strut profile 300 upon which the embodiments of the invention may be implemented. The aluminum profile 300 includes ridge portions 302 that form grooves 304. The aluminum profile 300 is used as a skeleton between the joints, as illustrated in FIG. 2. The aluminum profile 300 is shaped in a rigid manner to permit things to be attached to it. For example, ridges 302 serve as rails permitting attachment of a camera to the profile 300 and ultimately to the set to facilitate easy movement up and down, back and forth. The profile design also allows, for example, for elevator doors and sliding doors to move along the profile 300. The profile 300 is not unique to the instant embodiments. Instead, the profile 300 is a standard design that is available.

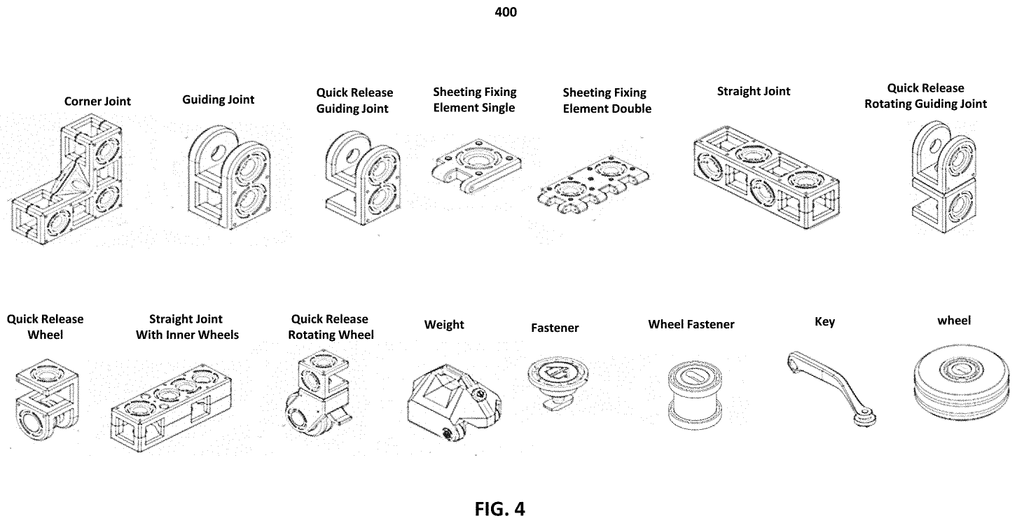

FIG. 4 illustrates various exemplary components 400 associated with the embodiment shown in FIG. 2 and discussed more fully in the sections that follow. Various joints depicted in FIG. 4 include a corner joint, guiding joint, quick release joint, a straight joint, and a quick release rotating guiding joint. Some components are designed for movement, for example, up and down and back and forth along the profile 300.

Component movement conversely allows for movement of devices such as sliding doors, elevator doors and provides channels, for example, for cameras to move along the profile 300. These movable components are referred to as types of wheels. Exemplary wheels include a quick release wheel, a straight joint with inner wheels, and a quick release rotating wheel. A sheeting fixing element single and a sheeting fixing element double are also included, along with a regular fastener, a wheel fastener, a weight, and a key.

Although specific component designs are illustrated in FIG. 4, other shapes, configurations, and designs are acceptable and are within the spirit and scope of the present invention. Additionally, the exemplary components in FIG. 4 are constructed of an ultra-strong plastic material. However, other materials, such as metal alloys, rubber materials etc., would be suitable and within the spirit and scope of the present invention.

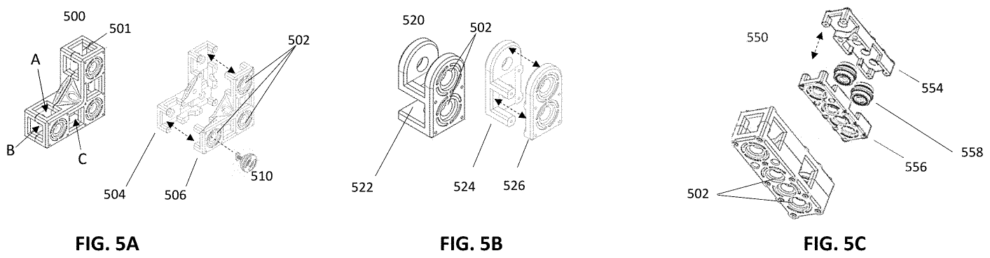

FIGS. 5A-5C illustrate various joint type components associated with the embodiments. FIG. 5A illustrates an exemplary corner joint 500. Corner joints, such as the corner joint 500, are used as connecting joints and fixing elements for the aluminum profile 300. The exemplary corner joint 500 includes openings, such as straight-through square slots 501, into which the profile 300 can be inserted. As such, the slots 501 guide the profile 300 in (3) different planes: (A), (B), and (C). By way of example, the corner joint 500 can also serve as a guide for strings and ropes.

When the corner joint 500 is connected with the profile 300, the corner joint 500 is opened by pulling apart two half portions 504 and 506. As illustrated in FIG. 5A, the corner joint 500 also includes round slots 502 for insertion of fastener 510. The fastener 510 serves to attach the two half portions 504 and 506 together. All the components, joint elements, and wheel components 400 shown in FIG. 4 include slots or openings, such as the round slots 502, through which the fastener 510 can be inserted. In alternative embodiments, there is a luminophore afterglow around the fastener slots for facilitating work in lowlight conditions.

In the embodiments, the corner joint 500 enables the creation of durable corners in the frame of a production set can be used to create frames for flats, stairs, doorways, windows bridges, ceilings etc. The corner joint 500 can be combined with other components 400 to create a variety of architectural forms, static and moving sets, sliding systems. These component combinations can also create mechanical, dynamic, and elevation mechanisms (e.g., elevators, garage door openers, sliding systems), along with forklift systems.

FIG. 5B is an illustration of an exemplary quick release guiding joint 520 modular component. The quick release guiding joint 520 also serves to guide the profile 300 in multiple planes. More specifically, the guiding joint 520 fixes profile(s) 300 in angular position to create supportive connections as well as supporting a diagonal arrangement of the profile(s) 300 (and facilitate mechanical movement) in the frame of the production set via an opening 522. If the mechanical movement is along the axis, the upper part of the element can be used as part of the axis while being fixed by its bottom part. The guiding joint 520 allows creation of an opening and movable mechanisms for production sets, such as a drawbridge. The guiding joint 520 includes two half portions 524 and 526.

In the description of the embodiments, the term quick release describes an ability to remove a component, such as the quick release guiding joint 520, already pre-installed in sections or profiles that are already secured by other joints from the production set. Stated another way, the quick release feature allows the adding and removal of components from the production set without having to take the entire set apart. Avoiding the need to take down the entire set is owed, in part, to the quick release function avoiding the need of the component being removed, from interacting with other components. In the embodiments, for example, several standard components also have “quick release” versions.

FIG. 5C illustrates a straight joint with inner wheels 550, similar in construction and operation to the corner joint 500 and the quick release guiding joint 520. For example, the straight joint 550 is formed of two half portions 554 and 556. Also included are wheels 558. By way of example only, and not limitation, the wheel 558 can be made from plastic with metallic parts inside which are secured by an internal wheel fastener and two external fasteners from both sides.

In addition to many of the features discussed above with reference to the corner joint 500 and the guiding joint 520, the straight joint 550 may also be used as a joint between massive and heavy constructions and can connect at least four different profiles 300. This arrangement makes very sustainable connections by merging multiple profiles into longer connections. The straight joint 550 also has the ability to be fixed in hard to access places or pre-assembled sets with a need for additional supportive connections or to support diagonal profiles.

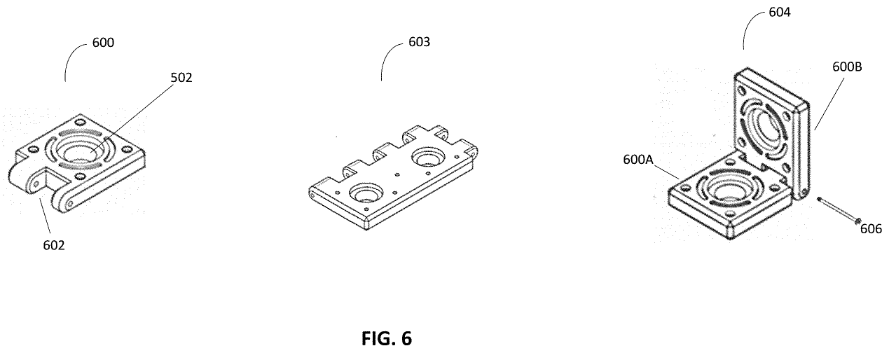

FIG. 6 illustrates an exemplary sheet fixing single element (i.e., wall piece element) 600, similar in construction and operation to the corner joint 500, the guiding joint 520, in the street joint 550 discussed above. In addition to features discussed above with reference to the other modular components, the primary function of the sheet fixing element 600 is fixing flats (which can be made of plywood, drywall, plastic sheeting, particle board etc., or any other standard flat construction material) to the frame of the production set.

The sheet fixing element 600 can be used to form niches, ramps, hills, pyramids, curved shapes and different oblique formations. It can also be used as a hinge for structures such as doors, when interlocked with another element. While the single sheet fixing element 600 is used more for hard to access places and lighter constructions, alternative sheet fixing element configurations are available, such as a double sheet fixing element 603, and are used for heavier constructions and easy to access places.

Sheet fixing elements can be joined together in a hinged configuration 608 using multiple elements, such as the elements 600A and 600B, interlocked and secured via an attaching mechanism 606. The sheet fixing element 600 is designed to be affixed to the back of the flat 201 rather than from the front, as is traditional in production set construction with screws and wood. This feature allows for the removal of the flat 201 without destroying the actual plywood or drywall.

The sheet fixing element 600 is essentially configured for attaching flats. As understood in the art, flats is an industry term for plywood, drywall, particleboard etc. the sheet fixing element 600 is the component facilitating attachment of the flat to the aluminum profile 300. Once attached to the frame, the flat can be painted or plastered, or have equipment attached to it. The sheet fixing element 600 permits attachment of the flat to the frame from inside the enclosure as opposed to the conventional approach—attaching from outside of the enclosure. This arrangement makes it easier to deconstruct the production set without destroying all the materials and components.

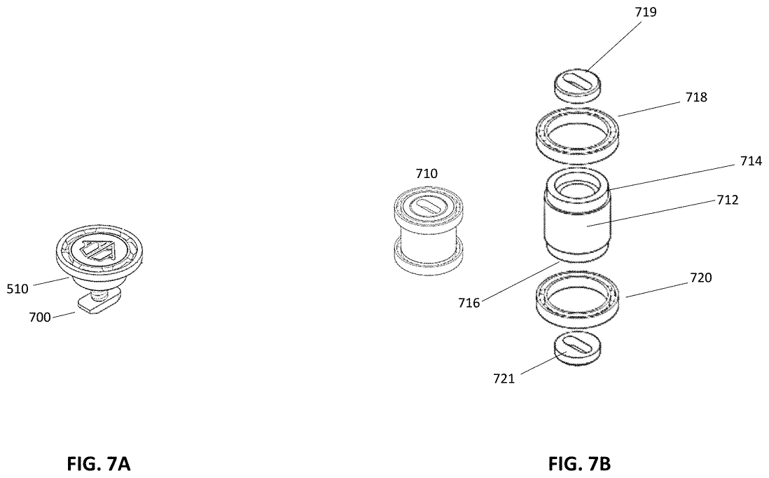

FIG. 7A illustrates an exemplary fastener 510 constructed in accordance with the embodiments. The fastener 510 (i.e., short fastener) is used to fasten the modular components (e.g., sheet fixing elements 600 and 603) of the embodiments to the aluminum profile 300, and to wheels etc. In the embodiments, fasteners work similar to a ¼ turning bolt and prevent the use of screwdrivers or Allen wrenches. In some embodiments, the fasteners are color-coded and can glow-in-the-dark. The fastener 510 includes a T-bolt 700 for securing the fastener 510.

FIG. 7B is an illustration of an exemplary wheel fastener 710 constructed and arranged in accordance with the embodiments. The wheel fastener 710 is used in every wheel and rotating joint (e.g., to create an axis) that has bearings inside to easily perform a rotating function and minimize friction. The wheel fastener 710 includes a cylindrical body portion 712, having a first end 714 and a second end 716.

Bearings 718 and 720 are configured for insertion in the first 714 and second 716 ends, respectively. The bearings 718 and 720 also include substantially identical inlets 719 and 721, respectively to be compatible with T-bolt extensions of regular fasteners or insertion of a unique key adapter. The substantially identical inlets 719 and 721 facilitate the quick addition or removal of an axis from the joints.

The unique key adapter is designed to facilitate quick installation and deconstruction, and to provide security so that only qualified personnel can release the fastener, and make changes to the production set. The key helps to minimize nefarious or unauthorized interference with the production set construction.

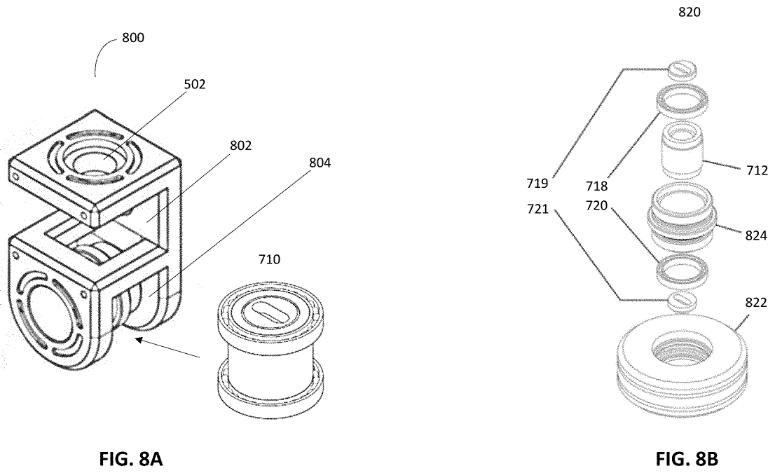

FIG. 8A is an exemplary illustration of a quick release wheel 800 constructed in accordance with the embodiments. The quick release wheel 800 literally functions as a wheel in the production set and allows creation of sliding mechanisms and movable construction components. The quick release wheel 800 includes a side slot 802 for accommodating the aluminum profile 300 and the round slots 502 for the fasteners 510 and 702.

In FIG. 8A, the wheel 710 is inserted into a chamber 804 to function as the wheel mentioned above and to facilitate fast and easy removal of the component from a desirable position without interacting with other components from the production set.

FIG. 8B is an exemplary illustration of a wheel 820 along with internal components. In addition to the internal components noted in the illustration of the wheel fastener 710 of FIG. 7B, the wheel 820 includes a wheel surface 822 and a wheel basis 824. The wheel 820 is a mechanism that can travel along the profile 300 and can be used with other components, such as joints, to create additional movable elements.

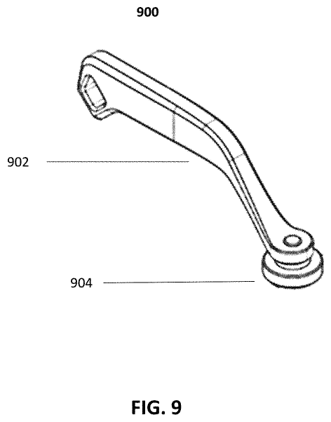

FIG. 9 illustrates an exemplary key 900 constructed in accordance with the embodiments. The key 900 facilitates easy locking and unlocking of the fasteners 510 and 702. The key 900 includes a handle 902 and a magnet 904 for quickly attaching to the fasteners 510 and 702. The key 900 provides a measure of security such that only qualified personnel can secure or release the fasteners (e.g., 510 and 702) by using the key 900 which minimizes the potential for tampering or outside interference. That is, components configured for using the key 900 cannot be operated or used, without the key 900.

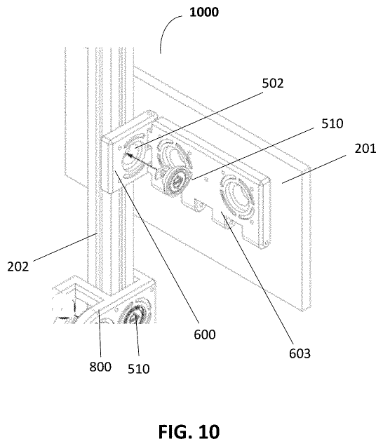

FIG. 10 is a more detailed illustration of an arrangement 1000 of attaching the flat 201 to the aluminum profile 202, depicted in FIG. 2. The arrangement 1000 uses the sheet fixing elements 600 and 603 of FIG. 6. In FIG. 10, the quick release wheel 800 is secured to the aluminum profile 202 with the fastener 510. The sheet fixing element single 600 is secured to the aluminum profile 202 with another fastener 510 via the opening 502. The sheet fixing element double 603 can be attached to the flat 201 via one or more additional fasteners 502.

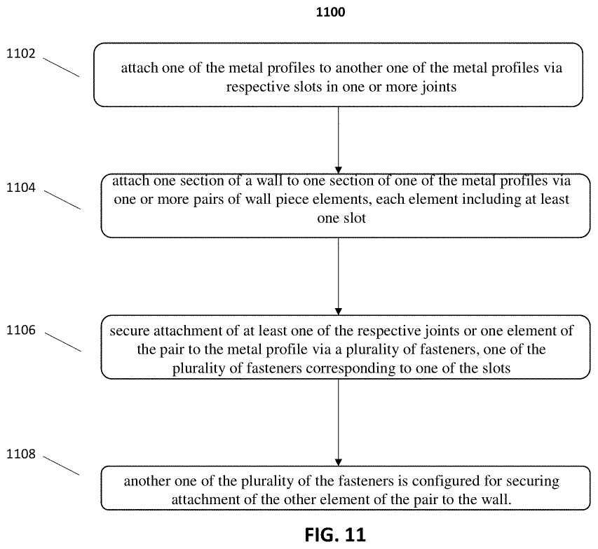

FIG. 11 is a flowchart of an exemplary method 1100 of practicing an embodiment of the present invention. In the method 1100, one of the metal profiles is attached to another one of the metal profiles via respective slots in one or more joints in step 1102. In step 1104 one section of a wall is attached to one section of one of the metal profiles via one or more pairs of wall piece elements, each element including at least one slot in step 1104. In step 1106, attachment is secured of at least one of the respective joints or one element of the pair to the metal profile via a plurality of fasteners, one of the plurality of fasteners corresponding to one of the slots, wherein another one of the plurality of the fasteners is configured for securing attachment of the other element of the pair to the wall in step 1108.

The modular nature of the embodiments make them suitable for wide adoption as standards, for example, within the film industry. The embodiments enable the construction of production sets faster, cheaper, with less labor, and with much less waste

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A modular system for assembling a structure including a frame formed of a metal profiles, the system comprising:
one or more joints, each including at least one slot and configured for attaching one of the metal profiles to another one of the metal profiles;
one or more pairs of wall piece elements, each pair for attaching one section of a flat to one section of one of the metal profiles; each element including at least one slot; and
a plurality of fasteners, one of the plurality of fasteners (i) corresponding to one of the slots (ii) and configured for securing attachment of at least one of the respective joints or one element of the pair to the metal profile;
wherein another one of the plurality of the fasteners is configured for securing attachment of the other element of the pair to the flat.

2. The modular system of claim 1, wherein the joints include two or more types of slots.

3. The modular system of claim 2, wherein one of the types of slots are configured for attaching to a profile and another one of the types of slots is configured for accommodating a fastener.

4. The modular system of claim 1, wherein the wall piece elements are sheet fixing elements.

5. The modular system of claim 4, wherein the joints and sheet fixing elements are formed of at least one from the group including plastic, rubber, and metal.

6. The modular system of claim 1, wherein the joints are configured operating with at least one of a regular fastener and a wheel fastener.

7. The modular system of claim 6, wherein the wheel fastener facilitates movement of the joint.

8. The modular system of claim 7, wherein each of the fasteners is securable via a key.

9. A wheel fastener for a modular system to assemble a structure including a frame formed of a plurality of metal profiles, the wheel fastener comprising:
a cylindrical chassis portion configured for insertion into a slot of at least one of a joint and a sheet fixing element; and
first and second bearings, each (i) having a slot therethrough and (ii) configured for placement at respective ends of the chassis portion;
wherein the wheel fastener secures attachment of at least one of the joint and the sheet fixing element to at least one of the plurality of metal profiles; and
wherein the slot is configured for placement of a locking key for locking placement of the corresponding joint or sheet fixing element into position.

10. The wheel fastener of claim 9, further comprising a cylindrical body having an opening at each end.

11. The wheel fastener of claim 10, further comprising a bearing inserted in each of the openings, the bearings facilitating movement of the wheel fastener.

12. The wheel fastener of claim 11, wherein each of the bearings includes a slot therethrough, the slots configured for insertion of a key.

13. A method for assembling a structure including a frame formed of metal profiles using a modular construction set, the method comprising:
attaching one of the metal profiles to another one of the metal profiles via respective slots in one or more joints;
attaching one section of a wall to one section of one of the metal profiles via one or more pairs of wall piece elements, each element including at least one slot; and
securing attachment of at least one of the respective joints or one element of the pair to the metal profile via a plurality of fasteners, one of the plurality of fasteners corresponding to one of the slots;
wherein another one of the plurality of the fasteners is configured for securing attachment of the other element of the pair to the wall.
